(19) United States
(12) Patent Application Publication
(10) Pub. No.: US 2015/0092086 A1
(43) Pub. Date: Apr. 2, 2015

(54) CMOS IMAGE SENSOR SYSTEM AND METHOD THEREOF

(71) Applicant: uChange Technology Co., Ltd., Taipei (TW)

(72) Inventors: Chih-Tsung CHANG, New Taipei City (TW); Jyun-Jie SIE, Hsinchu (TW)

(73) Assignee: uChange Technology Co., Ltd., Taipei (TW)

(21) Appl. No.: 14/306,230

(22) Filed: Jun. 17, 2014

(30) Foreign Application Priority Data
Sep. 29, 2013 (TW) 102127073

(51) Int. Cl. H04N 5/357; H04N 5/374

(52) U.S. Cl. CPC H04N 5/357; H04N 5/374
USPC 348/241

(57) ABSTRACT

A complementary metal-oxide semiconductor (CMOS) image sensor system and method thereof produce a control signal to make a input terminal repeatedly switch between high potential and low potential, thereby modulating image signals at a specific frequency to prevent image quality from being affected by direct current (DC) voltage variations. The mechanism thus helps improving the image quality.

### CROSS-REFERENCE TO RELATED APPLICATION

This application claims priority to TAIWAN Patent Application Ser. No. 102127073, filed Jul. 29, 2013, the entireties of which is incorporated herein by reference.

### TECHNICAL FIELD

The invention relates to an image sensor system and, in particular, to a CMOS image sensor system that utilizes CMOS as an active pixel image sensor. The invention also relates to the method thereof.

### BACKGROUND ART

### Description of Related Art

In recent years, rapid developments and popularity of semiconductor technology have enabled complementary metal-oxide semiconductor (CMOS) image sensors to compete with charge coupled device (CCD) sensors. Particularly in the low-end market, the CMOS image sensors have a lower cost because they do not require a special manufacturing process. Therefore, the CMOS image sensors have become the mainstream in the low-end market.

Generally speaking, the quality of images produced by a CMOS image sensor is not as good as that by a CCD image sensor. Nevertheless, the CMOS has a lower cost and is power-effective, posing a large attraction for portable devices. It is thus the primary issue for vendors to improve the image quality of CMOS.

In view of this, some propose to improve the manufacturing process and packaging method. For example, the integrated technology of backside illumination (BSI) and through-silicon via (TSV) has been proposed to improve the image quality. However, this method cannot be applied to the CMOS image sensor made using conventional process and packaging. On the other hand, new manufacturing processes and structures result in lower yield and higher cost. Therefore, the above-mentioned solution cannot effectively address the problem of bad image quality for CMOS.

In summary, the prior art always has the problem of bad image quality for CMOS image sensors. It is imperative to provide a better technique to solve the problem.

### SUMMARY

The invention discloses a CMOS image sensor system and the method thereof.

The disclosed system includes: a controlling unit, a sensor array, and a signal processing module. The controlling unit generates a control signal to make a input terminal repeatedly switch between high and low potentials. The sensor array includes at least one active pixel sensor unit. After each of the active pixel sensor units detects light and produces charges, direct current (DC) and alternating current (AC) signals are generated according to the high/low potential on the input terminal. The DC and AC signals are output to a column output. The signal processing module is electrically connected with the sensor array to filter out the DC current, receiving only the AC signal from the column output, to avoid DC voltage variations and noise interference. The signal processing module further processes the AC signal to generate an image signal.

The disclosed method includes the steps of: generating a controlling signal to make a input terminal repeatedly switch between high and low potentials; after detecting light and generating charges, generating DC and AC signals according to the high/low potential on the input terminal, and outputting the DC and AC signals to the column output; filtering out the DC signal from the column output and receiving only the AC signal to avoid DC voltage variations and noise interference, and processing the AC signal to generate an image signal.

The disclosed system and method differ from the prior art in that the controlling signal is produced to switch the input terminal between the high and low potentials, thereby modulating the image signal at a specific frequency to prevent DC voltage variations and noise interference from affecting the image quality.

Through the above-mentioned technique, the invention can improve the image quality.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed CMOS image sensor system;

FIGS. 2A and 2B are flowcharts of the disclosed CMOS image sensor method;

FIGS. 3A and 3B are schematic views of the disclosed signal processing module; and

FIG. 4 shows waveforms of signals at various terminals of the invention.

FIG. 5 shows the waveforms of signals at various terminals of a conventional CMOS image sensor.

### DETAILED DESCRIPTION

The present invention will be apparent from the following detailed description, which proceeds with reference to the accompanying drawings, wherein the same references relate to the same elements.

Before describing the disclosed CMOS image sensor and the method thereof in detail, we first explain the structure of the invention. The invention differs from the prior art in that in the active pixel sensor unit, the input terminal repeatedly switches between high and low potentials to obtain DC and AC signals. The DC signal is then filtered out, leaving the AC signal to be detected and used for image formation. In comparison, the prior art can only obtain and use the DC signal. Thus, the invention can prevent DC signal shifts due to differences in electronic properties, thereby avoiding bad image quality. The invention can be applied to a conventional sensor array and achieve the goal of image quality improvement. Besides, semiconductors have higher flicker noises on low-frequency and DC signals. Tuning the image signal at a specific frequency can reduce this interference, further improving the image quality. The specific frequency can be adjusted according to the intensity of light detected by the sensor array. As the light intensity increases, the frequency can be higher. The duty cycle of the specific frequency also can be adjusted according to the intensity of light detected by the sensor array. As the light intensity increases, the duty cycle can be longer. In addition to the above-mentioned method, one can also change the frequency range to adapt to different light intensities. As the light intensity increases, the frequency range is also enlarged.

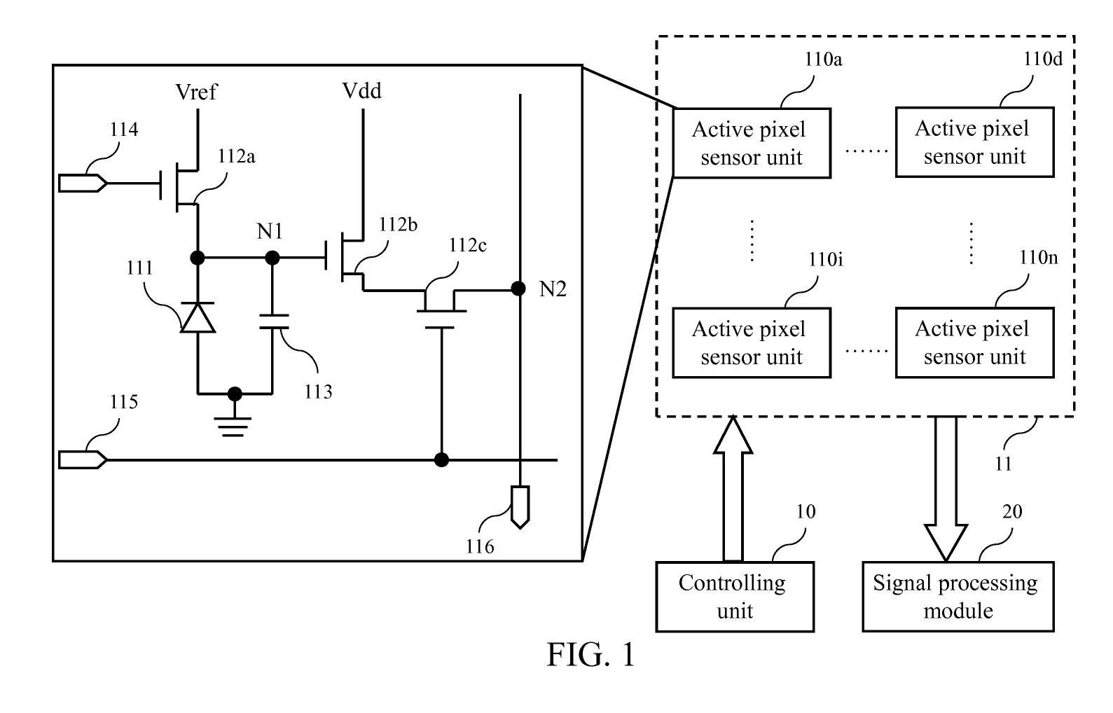

Please refer to FIG. 1, which is a block diagram of the disclosed CMOS image sensor system. The disclosed system includes: a controlling unit 10, a sensor array 11, and a signal processing module 20. The controlling unit 10 generates a control signal to make a input terminal 114 repeatedly switch between high and low potentials. In practice, the repeated switches mean that the potential is cyclically switched between high and low. The number of switches is such that the output image signal is sufficiently stable. Suppose the image signal can be stabilized after five switches between high and low potentials. The control signal generated by the controlling unit 10 controls the input terminal 114 to repeatedly switch between the high and low potentials for at least five times. We will describe the waveforms as the input terminal 114 switches between the high and low potentials with accompany figures.

The sensor array 11 includes at least one active pixel sensor unit 110a-110n. After each of the active pixel sensor units 110a-110n detects light and produces charges, DC and AC signals are generated according to the high/low potential on the input terminal 114. The DC and AC signals are output to a column output 116. In an embodiment of the invention, each of the active pixel sensor units 110a-110n includes a photodiode 111, transistor 112a-112c, a capacitor 113, a input terminal 114, a row select 115, and a column output 116. The photodiode 111 and the capacitor 113 are connected in parallel. The photodiode 111 can generate electric charges according to the light incident thereon. The row select 115 controls the transistor 112c for the charges generated by the photodiode 111 to be output to the column output 116. In practice, each of the active pixel sensor units 110a-110n can consist of three transistor active pixel sensors (3 T APS's) or four transistor active pixel sensors (4 T APS's). The invention does not put any restriction on the active pixel sensor units 110a-110n. Any element that can perform pixel sensing should be considered as part of the invention.

The signal processing module 20 is electrically connected with the sensor array 11 to filter out the DC current, receiving only the AC signal from the column output 116, to avoid DC voltage variations and noise interference. A high-pass filter is used to allow the passage of the AC signal from the column output 116. Afterwards, an amplifier amplifies the AC signal that passes through the high-pass filter. A rectifier or demodulator then performs half or full wave rectification or signal demodulation. The rectifier or demodulator converts the AC signal into a signal with a higher frequency and a DC signal. Finally, a low-pass filter smoothes the AC signal after the half or full wave rectification or demodulation, and outputs the final signal. Detailed features of the signal processing module 20 will be described with reference to accompanying figures later.

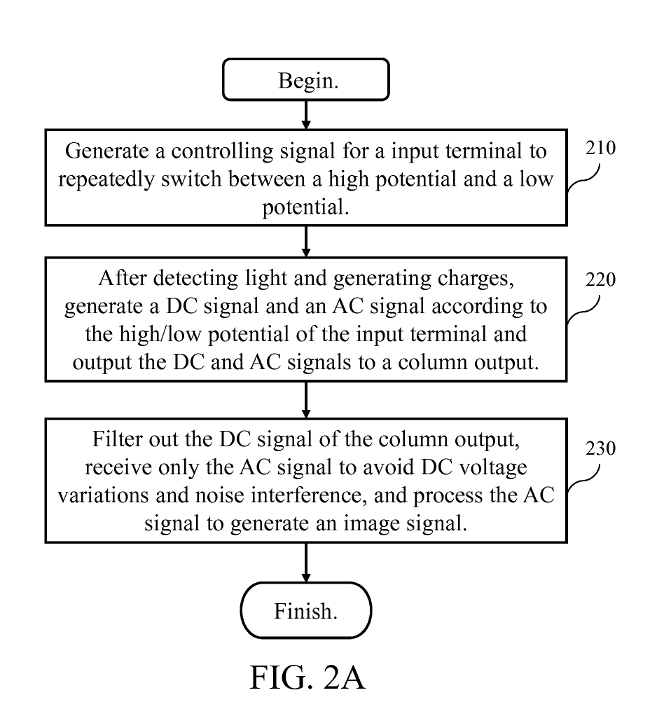

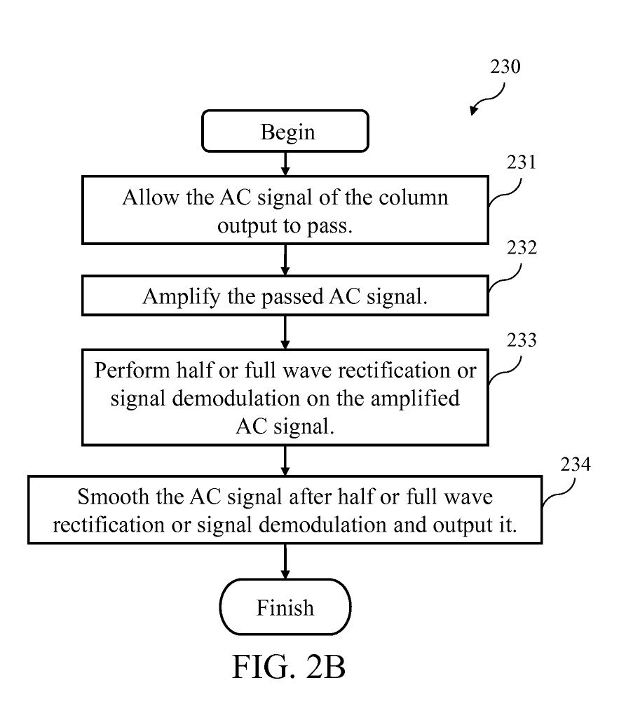

Please refer to FIGS. 2A and 2B, which are flowcharts of the disclosed CMOS image sensor method. The disclosed method includes the steps of: generating a control signal to make the input terminal 114 repeatedly switch between high and low potentials (step 210); after detecting light and generating charges, generating DC and AC signals according to the high/low potential on the input terminal 114, and outputting the DC and AC signals to the column output 116 (step 220); filtering out the DC signal from the column output 116 and receiving only the AC signal from the column output 116 to avoid DC voltage variations and noise interference, and processing the AC signal to generate an image signal (step 230). Through the above-mentioned steps, the control signal is generated for the input terminal 114 to repeatedly switch between high and low potentials, so that the image signal is modulated at a specific frequency, thereby preventing DC voltage variations and noise interference from deteriorating the image quality. In practice, the signal processing in step 230 is accomplished through the steps of: allowing the AC signal of the column output to pass (step 231); amplifying the passed AC signal (step 232); performing half or full wave rectification or signal demodulation on the amplified AC signal (step 233), smoothing the AC signal after half or full wave rectification or demodulation and outputting the signal (step 234).

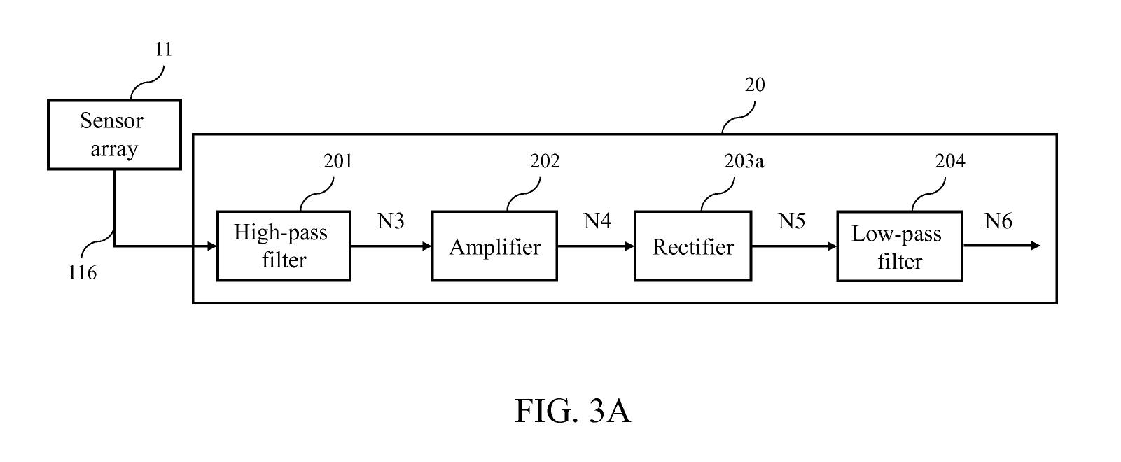

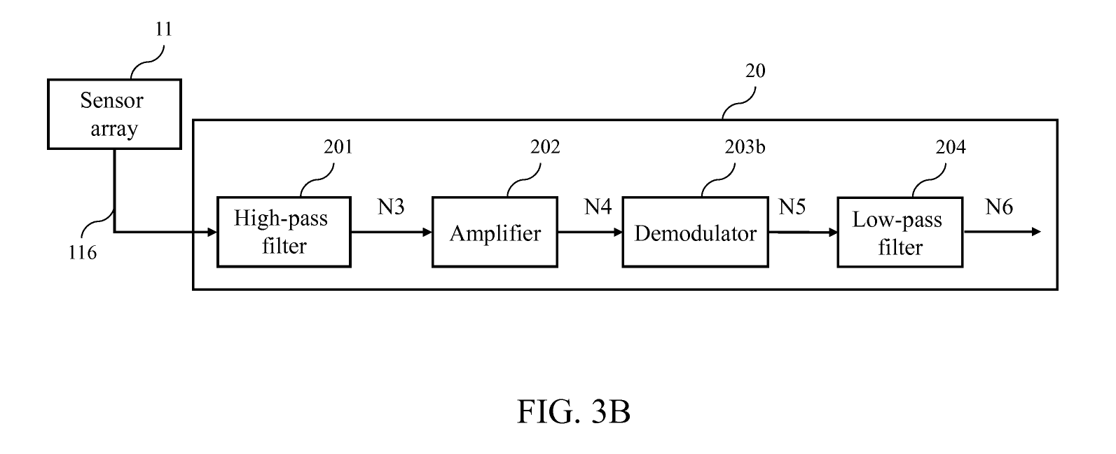

Please refer to FIGS. 3A to 5 for an embodiment of the invention. FIGS. 3A and 3B are schematic views of the disclosed signal processing module. As mentioned before, the signal processing module 20 filters out the DC signal of the column output. In practice, the signal processing module 20 includes a high-pass filter 201, an amplifier 202, a rectifier 203a, and a low-pass filter 204, as shown in FIG. 3A. The high-pass filter 201 is electrically connected to the column output 116 of the sensor array 11 to allow the AC signal of the column output 116 to go through. That is, the DC signal is filtered out, and only the AC signal is allowed to pass. The amplifier 202 is electrically connected to the high-pass filter 201 to amplify the AC signal passing through the high-pass filter 201. The rectifier 203a is electrically connected to the amplifier 202 to perform half or full wave rectification on the passed AC signal. The AC signal is then converted into a signal with a higher frequency and a DC signal. The low-pass filter 204 is electrically connected to the rectifier 203a to smooth the rectified AC signal and to output the final signal. Besides, the signal processing module 20 can use a demodulator 203b instead of the rectifier 203a, as shown in FIG. 3B. The other components are unchanged. The demodulator 203b demodulates the passed AC signal. The low-pass filter 204 smoothes the demodulated AC signal and outputs the result. The purpose of the above-mentioned half or full wave rectification or signal demodulation is to increase the original AC signal to a higher frequency. The difference between the two methods is merely in the circuit. For the convenience of reference to the waveforms at various terminals, the terminal between the high-pass filter 201 and the amplifier 202 is denoted by N3, that between the rectifier 203a or the demodulator 203b and the amplifier 202 by N4, that between the low-pass filter 204 and the rectifier 203a or the demodulator 203b by N5, and the output terminal of the low-pass filter 204 by N6.

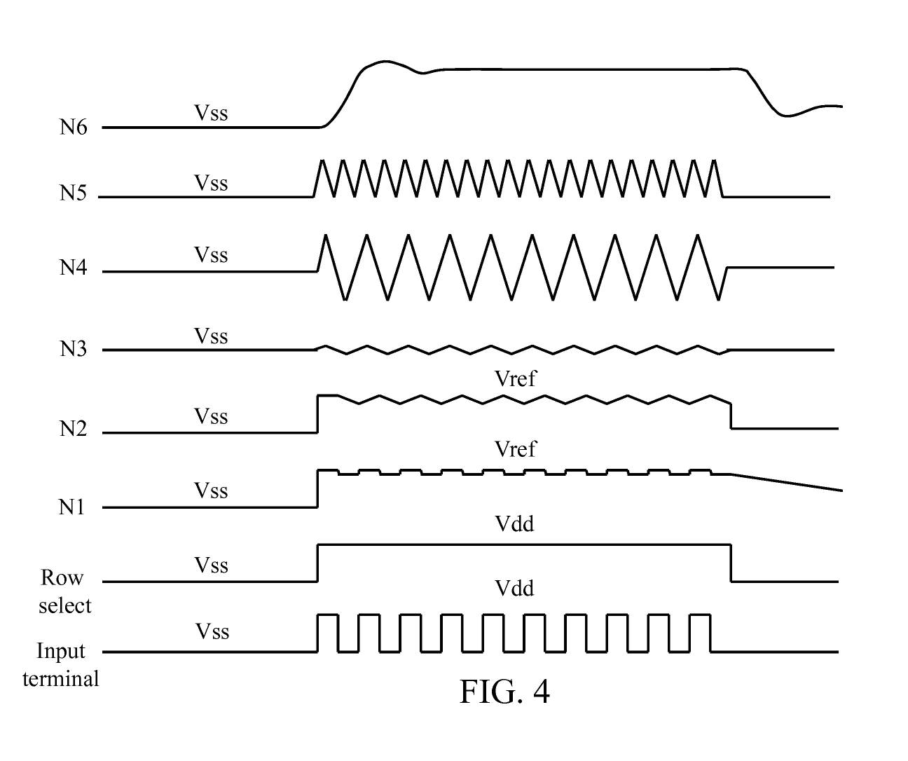

FIG. 4 shows waveforms of signals at various terminals of the invention. Please refer to FIGS. 1 and 3 at the same time. The control signal generated by the controlling unit 10 makes the waveform of the signal at the input terminal 114 switch rapidly between high and low potentials, as shown in FIG. 4. The high potential is denoted by Vdd, and the low potential by Vss. Take the active pixel sensor unit 110a of FIG. 1 as an example. The input terminal 114 repeatedly switch between the high and low potentials, the input terminal 114 electrically connects to the gate of the transistor 112a, the drain of the transistor 112a electrically connects to the high potential Vref, and the source of the transistor 112a electrically connects to the photodiode 111. Therefore, the waveform at terminal N1 switches from the low potential Vss to the high potential Vref. As the switch time of the input terminal 114 between the high and low potentials is very short, the waveform at terminal N1 is maintained at the high potential Vref during the switches of the input terminal 114, as shown in FIG. 4. Besides, the gate of the transistor 112b electrically connects to terminal N1. The drain of the transistor 112b electrically connects to the high potential Vdd. The source of the transistor 112b electrically connects to the drain of the transistor 112c. The gate of the transistor 112c electrically connects to the row select 115. The source of the transistor 112c electrically connects to the column output 116 (i.e., terminal N2). Therefore, terminal N2 has a triangle wave at the AC part, as shown in FIG. 4. This waveform is processed by the high-pass filter 201 to produce the waveform at terminal N3 in FIG. 4. The amplifier 202 amplifies the waveform of terminal N3 to generate the waveform at terminal N4. The waveform at terminal N4 is processed with half or full wave rectification or signal demodulation by the rectifier 203a or the demodulator 203b to generate the waveform at terminal N5. Finally, the low-pass filter 204 smoothes the waveform at terminal N5 and outputs the waveform at terminal N6. After the above-mentioned processing, the image signal is modulated to a specific frequency (e.g., high frequency) to avoid the problem of bad image quality due to DC voltage variations. Since the image signal is modulated to a higher frequency, the invention can further avoid the problem of noises of semiconductors at low frequencies and DC signals. It should be mentioned that the waveforms at terminal N1 and terminal N2 have different heights due to their different electronic properties. However, after the high-pass filter, the waveforms at terminal N3 and terminal N6 do not have any difference in height due to electronic properties.

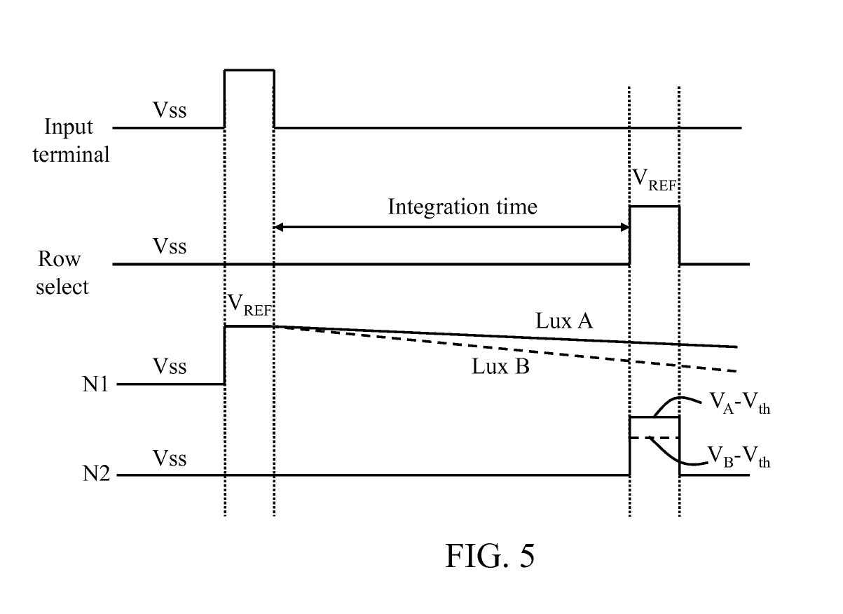

Finally, please refer to FIG. 5 for the waveforms of signals at various terminals of a conventional CMOS image sensor. Different from the repeated switches between high and low potentials at the input terminal 114, terminal N1 is raised to the high potential V_{REF} as the input terminal switches from the low potential to the high potential in the prior art. When the row select still stays at the low potential Vss, no signal is output and the input terminal switches from the high potential to the low potential. This period of time until the row select switches from the low potential to the high potential is called the photodiode integration time. During this period, the potential of terminal N1 drops with time until the row select switches from the low potential to the high potential for signal output.

In summary, the disclosed system and method differ from the prior art in that the controlling signal is produced to switch the input terminal between the high and low potentials, thereby modulating the image signal at a specific frequency to prevent DC voltage variations and noise interference from affecting the image quality. Through the above-mentioned technique, the invention can improve the image quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A complementary metal-oxide semiconductor (CMOS) image sensor system, comprising:
a controlling unit for generating a control signal for a input terminal to repeatedly switch between a high potential and a low potential;
a sensor array consisting of at least one active pixel sensor unit, each of which generates a direct current (DC) signal and an alternating current (AC) signal according to the high/low potential of the input terminal after detecting light and generating charges, the DC signal and the AC signal being output to a column output; and
a signal processing module electrically connected with the sensor array for filtering out the DC signal and receiving only the AC signal from the column output to avoid DC voltage variations and noise interference, and for processing the AC signal to generate an image signal.

2. The CMOS image sensor system of claim 1, wherein the signal processing module further includes:
a high-pass filter electrically connected with the column output for allowing the AC signal of the column output to pass;
an amplifier electrically connected with the high-pass filter for amplifying the AC signal passing through the high-pass filter;
a demodulator electrically connected with the amplifier for demodulating the amplified AC signal; and
a low-pass filter electrically connected with the demodulator for smoothing the demodulated AC signal and outputting the final signal.

3. The CMOS image sensor system of claim 1, wherein the signal processing module further includes:
a high-pass filter electrically connected with the column output for allowing the AC signal of the column output to pass;
an amplifier electrically connected with the high-pass filter for amplifying the AC signal passing through the high-pass filter;
a rectifier electrically connected with the amplifier for performing half or full wave rectification on the amplified AC signal; and
a low-pass filter electrically connected with the demodulator for smoothing the demodulated AC signal and outputting the final signal.

4. The CMOS image sensor system of claim 1, wherein when the input terminal repeatedly switch between high and low potentials the image signal is modulated at a specific frequency that allows to be adjusted.

5. The CMOS image sensor system of claim 4, wherein the specific frequency is an AC signal resistant from noise interference.

6. The CMOS image sensor system of claim 1, wherein when the input terminal repeatedly switch between high and low potentials the image signal is modulated at a specific frequency whose duty cycle changes with light intensity detected by the sensor array, with the light intensity becomes stronger as the duty cycle being longer or, conversely, the light intensity becomes weaker as the duty cycle being shorter.

7. The CMOS image sensor system of claim 6, wherein the specific frequency is an AC signal resistant from noise interference.

8. A CMOS image sensor method, comprising the steps of:
generating a control signal for a input terminal to repeatedly switch between a high potential and a low potential;
generating a DC signal and an AC signal according to the high/low potential of the input terminal after detecting light and generating charges, and outputting the DC signal and the AC signal to a column output; and
filtering out the DC signal and receiving only the AC signal from the column output to avoid DC voltage variations and noise interference, and processing the AC signal to generate an image signal.

9. The CMOS image sensor method of claim 8, wherein the step of processing the AC signal further includes the steps of:
allowing the AC signal from the column output to pass;
amplifying the passed AC signal;
performing half or full wave rectification or signal demodulation on the amplified AC signal; and
smoothing the AC signal after half or full wave rectification or signal demodulation and outputting the resulting signal.

10. The CMOS image sensor method of claim 8, wherein when the input terminal repeatedly switch between high and low potentials the image signal is modulated at a specific frequency that allows to be adjusted.

11. The CMOS image sensor method of claim 10, wherein the specific frequency is an AC signal resistant from noise interference.

12. The CMOS image sensor method of claim 8, wherein when the input terminal repeatedly switch between high and low potentials the image signal is modulated at a specific frequency whose duty cycle changes with light intensity detected by the sensor array, with the light intensity becomes stronger as the duty cycle being longer or, conversely, the light intensity becomes weaker as the duty cycle being shorter.

13. The CMOS image sensor method of claim 12, wherein the specific frequency is an AC signal resistant from noise interference.
